(19) United States
(12) Patent Application Publication
(10) Pub. No.: US 2009/0227310 A1
(43) Pub. Date: Sep. 10, 2009

(54) Playing Method Of Card Game And Game Machine

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/138,123

(22) Filed: Jun. 12, 2008

Related U.S. Application Data
(60) Provisional application No. 61/034,703, filed on Mar. 7, 2008.

(51) Int. Cl. A63F 13/02; A63F 13/10; A63F 13/12; A63F 9/24

(52) U.S. Cl. 463/13; 463/27; 463/30; 463/43; 463/40; 273/292

(57) ABSTRACT

A game machine of the present invention includes: a plurality of first display devices provided corresponding to respective ones of a plurality of players; a second display device provided in common by the plurality of players; and a controller for controlling the first display devices and the second display device, the controller being operable to: execute a side game in a case where a predetermined condition is met in the basic game; determine, on the plural-players basis, card combinations in which payments are paid out, from among plural kinds of cards in the basic game, and then, display the determined card combination on at least one of each of the first display devices and the second display device; display, on the first display devices, a plurality of cards after dealt on the plural-players basis and display, on the second display device, a plurality of cards displayed on the first display devices and owned by the players, from among the plural kinds of cards in the side game; and pay out a payment, based upon the combination determined in a case where all of the plurality of cards displayed on a player-by-player basis include the card combination determined on the plural-players basis.

### CROSS-REFERENCE TO RELATED APPLICATIONS

This application claims priority of U.S. Provisional Application No. 61/034,703 filed on Mar. 7, 2008. The contents of this application are incorporated herein by reference in their entirety.

### BACKGROUND OF THE INVENTION

1. Field of the Invention

The present invention relates to a method of playing card games and a game machine.

2. Description of the Related Art

Conventionally, card games such as poker, blackjack, and baccarat, have been known which a plurality of players enjoy in gaming places such as casinos. These card games are generally performed between players and a dealer actually using betting chips.

The above-mentioned card games include: live-type card games in which players compete against a real dealer; and video-type, table-type card games in which players compete against a virtual dealer displayed on a video display. The video-type card games employs a game system in which the video display device displays an image of the virtual dealer who takes action to deal cards and deliver chips, and then, game programs are processed and implemented, as if card games were performed between each of the players and the real dealer.

For example, US Published Patent Application No. 2005/0035548 discloses a table game system, including: a video display device, which displays a virtual dealer and game cards; and a plurality of player stations provided integrally with a dealer table so as to accept a game start operation such as BET from players and surround the dealer table. In this game system, the video display device serves to display cards automatically shuffled by a computer while displaying the virtual dealer by way of image, so that a plurality of players at a plurality of player stations perform card games.

The abovementioned conventional game system has been disadvantageous in that the dealer and the plurality of players at the plurality of player stations can perform card games, whereas there is no chance to perform games among the plurality of players. Therefore, a need exists for the advent of gaming methods and machines with new entertainability.

The present invention has been made in view of the above-described circumstance. It is an object of the invention to provide a novel gaming method and machine by enhancing the entertainability of card games among the plurality of players.

### SUMMARY OF THE INVENTION

A first aspect of the present invention is a game machine, including: a plurality of first display devices provided corresponding to respective ones of a plurality of players; a second display device provided in common to the plurality of players; and a controller for controlling the first display devices and the second display device, the controller being programmed to: (a) execute a basic game; (b) display a predetermined number of players' cards on the first display devices and display a predetermined number of banker's cards on the second display, in the basic game; (c) pay out to at least one of the players a payment determined by comparing the players' cards with the banker's cards displayed in the process (b), in the basic game; (d) execute a side game in a case where a predetermined condition is met, in the basic game; (e) determine, on the plural-players basis, card combination in which a payment is to be paid out, from among plural kinds of cards and then, display the determined card combination on at least one of each of the first display devices and the second display device, in the side game; (f) display, on the first display devices, a plurality of cards dealt on the plural-players basis and display, on the second display device, a plurality of cards displayed on the first display devices and owned by the players, from among the plural kinds of cards, in the side game; and (g) pay out a payment, based upon the combination determined in the process (e), in a case where the plurality of cards displayed on a player-by-player basis in the process (f) include the card combination determined on the plural-players basis in the process (e), in the side game.

According to the game machine constituted as set forth below, a card combination in which a payment is to be paid out is displayed in a side game on a player-by-player basis. In a case where all of plural cards after dealt to a plurality of players, which were displayed on a common display device, include a card combination in which a payment is to be paid out, the payment is paid out. Therefore, in a case where a card combination “One Pair” or “Two Pairs” is displayed when the side game is started, for example, if five cards after dealt to each of all the players include the card combination “One Pair” or “Two Pairs”, the payment is paid out based upon the card combination, thus making it possible to enhance entertainability of card games among a plurality of players.

A second aspect of the present invention is the game machine of the first aspect, further including a memory for storing game historical data for consisting of winner-loser data of a past game accumulatively stored and table data for determining a card combination in which a payment is to be paid out, wherein: the controller determines a plurality of card combinations in which the payments are to be paid out on the plural-players basis, with referring to the table data, according to the past winner-loser data that is based upon the game historical data stored in the memory, in the process (e).

According to the game machine constituted as set forth below, a plurality of card combinations in which payments are to be paid out are determined depending upon the past win/loss in a side game. Therefore, in a case where a large number of accumulated BETs and a small number of wins take place, for example, a small number of card combinations in which payments are to be paid out are determined, thereby making it possible to enhance entertainment of card games among the plurality of players.

A third aspect of the present invention is the game machine of the first aspect, further including an input device for accepting operation from a player, wherein: the controller is programmed to (h) accept entry of a side BET that is different from a normal BET from the input device, and then, pay out a payment to only at least one of the players having entered the side BET in the process (g).

According to the game machine constituted as set forth below, a card combination in which a payment is to be paid out is displayed on a player-by-player basis in a side game. In a case where all of plural cards after dealt to a plurality of players, which were displayed on a common display, include a card combination in which a payment is to be paid out, the payment is paid out only at least one of the players having entered a side BET. Therefore, in a case where a card combination “One Pair” or “Two Pairs” is displayed on the display device when a side game is started, for example, if five cards after dealt to each of all the players include either of the card combinations “One Pair” and “Two Pairs”, the payment is paid out to only at least one of the players having entered the side BET, thereby making it possible to enhance entertainability of card games among the plurality of players.

A fourth aspect of the present invention is the game machine of the third aspect, wherein: the controller distributes and pays out the payment among all of the players having entered the side BET, in the process (g).

According to the game machine constituted as set forth below, a card combination in which a payment is to be paid out is displayed on a player-by-player basis in a side game. In a case where all of plural cards after dealt to a plurality of players, which were displayed on a common display, include a card combination in which a payment is to be paid out, the payment is distributed and paid out among players having entered side BETs. Therefore, in a case where a card combination “One Pair” or “Two Pairs” is displayed on the display device when a side game is started, if five cards after dealt to each of all the players include the combination “One Pair” or “Two Pairs”, the payment is distributed among the players having entered the side BETs, thereby making it possible to enhance entertainability of card games among the plurality of players.

A fifth aspect of the present invention is the game machine of the first aspect, wherein: the controller is programmed to: (i) execute processing of determining the player to whom a payment is to be paid out, from among the plurality of players; and the controller pays out, in the process (g), the payment determined in the process (i).

According to the game machine constituted as set forth below, a card combination in which a payment is to be paid out is displayed on a player-by-player basis in a side game. In a case where all of plural cards after dealt to a plurality of players, which were displayed on a common display, include a card combination in which a payment is to be paid out, a player to whom a payment is to be paid out is determined from among the players having entered the side BETs. Therefore, in a case where a card combination “One Pair” or “Two Pairs” is displayed on the display device when a side game is started, if five cards after dealt to each of all the players include either of the card combinations “One Pair” and “Two Pairs”, a player to whom a payment is to be randomly paid out is determined from among the players having entered the side BETs, thereby making it possible to enhance entertainability of card games among the plurality of players.

A sixth aspect of the present invention is a game machine, including: a plurality of first display devices provided corresponding to respective ones of a plurality of players; a second display device provided in common to the plurality of players; and a memory for storing game historical data for consisting of winner-loser data of a past game accumulatively stored and table data for determining a card combination in which a payment is to be paid out, a controller for controlling the first display devices, the second display device and the memory, the controller being programmed to: (a) execute a basic game; (b) display a predetermined number of players' cards on the first display devices and display a predetermined number of banker's cards on the second display, in the basic game; (c) pay out to at least one of the players a payment determined by comparing the players' cards with the banker's cards displayed in the process (b), in the basic game; (d) execute a side game in a case where a predetermined condition is met in the basic game; (e) determine, on the plural-players basis, a plurality of card combinations in which payments are to be paid out, from among plural kinds of cards, with referring to the table data, according to past winner-loser data that is based upon the game historical data stored in the memory in the side game, and then, display the determined card combinations on at least one of the first display devices and the second display device; (f) display, on the first display devices, a plurality of cards dealt on the plural-players basis, and display, on the second display device, a plurality of cards displayed on the first display devices and owned by the players, from among the plural kinds of cards, in the side game; and (g) pay out a payment, based upon the combination determined in the process (e), in a case where the plurality of cards displayed on a player-by-player basis in the process (f) include the card combination determined on the plural-players basis in the process (e), in the side game.

According to the game machine constituted as set forth below, a plurality of card combinations in which payments are to be paid out are determined depending upon the past win/loss in a side game. Therefore, in a case where a large number of accumulated BETs and a small number of wins take place, for example, a large number of card combinations in which payments are paid out are determined. In a case where a small number of accumulated BETs and a large number of wins take place, a small number of card combinations in which payments are to be paid out are determined, thereby making it possible to enhance entertainability of card games.

A seventh aspect of the present invention is the game machine of the sixth aspect, further including: an input device for accepting operation of a player, wherein: the controller is programmed to: (h) accept entry of a side BET that is different from a normal BET from the input device, and then, pay out a payment to only at least one of the players having entered the side BET in the process (g).

According to the game machine constituted as set forth below, a card combination in which a payment is to be paid out in a side game is displayed on a player-by-player basis. In a case where all of a plurality of cards after dealt to a plurality of players, which were displayed on the common display device, include a card combination in which a payment is to be paid out, the payment is paid out to only at least one of the players having entered a side BET. Therefore, in a case where the card combination “One Pair” or “Two Pairs” is displayed on the display device when a side game is started, for example, if five cards after dealt to each of all the players include either of the combinations “One Pair” and “Two Pairs”, the payment is paid out to only at least one of the players having entered the side BET, thus making it possible to enhance entertainability of card games among the plurality of players.

An eighth aspect of the present invention is the game machine of the seventh aspect, wherein: the controller distributes and pays out the payment among all of the players having entered the side BET in the process (g).

According to the game machine constituted as set forth below, a card combination in which a payment is to be paid out in a side game is displayed on a player-by-player basis. In a case where all of a plurality of cards after dealt to a plurality of players, which were displayed on the common display device, include a card combination in which a payment is to be paid out, the payment is distributed and paid out among the players having entered the side BETs. Therefore, in a case where the card combination “One Pair” or “Two Pairs” is displayed on the display device when a side game is started, for example, if five cards after dealt to each of all the players include either of the combinations “One Pair” and “Two Pairs”, the payment is paid out to only at least one of the players having entered the side BET, thus making it possible to enhance entertainability of card games among the plurality of players.

A ninth aspect of the present invention is the game machine of the seventh aspect, wherein: the controller is programmed to: (i) execute a process of determining a player to whom a payment is to be paid out, from among the plurality of players; and the controller pays out, in the process (g), the payment to the player determined in the process (i).

According to the game machine constituted as set forth below, a card combination in which a payment is to be paid out in a side game is displayed on a player-by-player basis. In a case where all of a plurality of cards after dealt to a plurality of players, which were displayed on the common display device, include a card combination in which a payment is to be paid out, a player to whom a payment is to be paid out is determined from among the players having entered the side BETs. Therefore, in a case where a card combination “One Pair” or “Two Pairs” is displayed on the display device when a side game is started, a player to whom a payment is to be randomly paid out is determined from among the players having entered the side BETs, thus making it possible to enhance entertainability of card games among the plurality of players.

A tenth aspect of the present invention is a game machine, including: a plurality of first display devices provided corresponding to respective ones of a plurality of players; a second display device provided in common to the plurality of players; and a memory for storing game historical data for consisting of winner-loser data of a past game accumulatively stored and table data for determining a card combination in which a payment is to be paid out; an input device for accepting operation from a player; a controller for controlling the first display devices, the second display device, the memory and the input device, the controller being programmed to: (a) execute a basic game; (b) display a predetermined number of players' cards on the first display devices and display a predetermined number of banker's cards on the second display in the basic game; (c) pay out to at least one of the players a payment determined by comparing the players' cards displayed in the process (b) with the banker's cards, in the basic game; (d) execute a side game in a case where a predetermined condition is met in the basic game; (e) determine, on the plural-players basis, a plurality of card combinations in which payments are to be paid out, from among plural kinds of cards, with referring to the table data, according to past winner-loser data that is based upon the game historical data stored in the memory in the side game, and then, display the determined card combinations on at least one of the first display devices and the second display device; (f) display, on the first display devices, a plurality of cards dealt on the plural-players basis and display, on the second display device, a plurality of cards displayed on the first display devices and owned by the players, from among the plural kinds of cards, in the side game; (g) accept entry of a side BET that is different from a normal BET from the input device in the side game; and (h) pay out a payment, based upon a card combination determined for only the player having entered the side BET in the process (g), in a case where the plurality of cards displayed on a player-by-player basis in the process (g) include the card combination determined on the plural-players basis in the process (e).

According to the game machine constituted as set forth below, a card combination in which a payment is to be paid out in a side game is displayed on a player-by-player basis. In a case where all of a plurality of cards after dealt to a plurality of players, which were displayed on the common display device, include a card combination in which a payment is to be paid out, the payment is paid out to only at least one of the players having entered a side BET. Therefore, in a case where the card combination “One Pair” or “Two Pairs” is displayed on the display device when a side game is started, for example, if five cards after dealt to each of all the players include either of the card combinations “One Pair” and “Two pairs”, the payment is paid out to only at least one of the players having entered the side BET, thus making it possible to enhance entertainability of card games among the plurality of players.

An eleventh aspect of the present invention is a game method, including the steps of: (a) dealing to players a predetermined number of cards as players' cards and dealing to a banker a predetermined number of cards as banker's cards, in a basic game; (b) paying out to one of the players a payment determined by comparing the players' cards with the banker's cards in the basic game; (c) determining, on a plural-players basis, a card combination in which a payment is to be paid out, from among plural kinds of cards in a side game; (d) dealing a plurality of cards to a plurality of players, respectively, from among plural kinds of cards in the side game; (e) arranging a plurality of cards owned by the plurality of players in a state in which kinds of the plurality of cards are identified to the plurality of players in the side game; and (f) paying out a payment to a player, based upon the card combination in which a payment is to be paid out determined in the step (c), in a case where the plurality of cards arranged on the player-by-player basis in the side game include the card combinations determined on the plural-players basis in the step (c).

According to the game machine constituted as set forth below, a card combination in which a payment is to be paid out in a side game is determined on a player-by-player basis, and a plurality of cards after dealt to the plurality of players are arranged in a state in which their kinds are identified. In a case where all of a plurality of cards after dealt to a plurality of players, which were displayed on the common display device, includes a card combination in which a payment is to be paid out, the payment is paid out. Therefore, in a case where a card combination “One Pair” or “Two Pairs” is displayed on the display device when a side game is started, for example, if five cards deal to each of all the players include either of the card combinations “One Pair” and “Two Pairs”, the payment is paid out based upon the card combination, thus making it possible to enhance entertainability of card games among the plurality of players.

A twelfth aspect of the present invention is the game method of the eleventh aspect, wherein: the step (c) comprises the step of determining a plurality of card combinations in which the payments are to be paid out on the plural-players basis, according to a past game winner/loser log.

According to the game method set forth above, a plurality of card combinations in which payments are paid out are determined depending upon the past win/loss in a side game. Therefore, in a case where a large number of accumulated BETs and a small number of wins take place, a large number of card combinations in which the payments are to be paid out are determined; and in a case where a small number of accumulated BETs and a large amount of wins take place, a small amount of card combinations in which payments are to be paid out is determined, thereby making it possible to enhance entertainability of card games.

A thirteenth aspect of the present invention is the game method of the eleventh aspect, wherein: the step (c) includes the step of (g) accepting a side BET that is different from a normal BET, wherein: the step (f) comprises the step of paying out a payment to only at least one of the players having performed the side BET.

According to the game method set forth below, a card combination in which a payment is to be paid out in a side game is determined on a player-by-player basis, and a plurality of cards after dealt to the plurality of players are arranged in a state in which their kinds are identified. In a case where all of a plurality of cards after dealt to a plurality of players, which were displayed on the common display device, include a card combination in which a payment is to be paid out, the payment is paid out to only at least one of the players having entered the side BETs. Therefore, in a case where a card combination “One Pair” or “Two Pairs” are determined on the display device when a side game is started, for example, if all of a plurality of cards after dealt to a plurality of players include either of the card combinations “One Pair” and “Two Pairs”, the payment is paid out to a player having entered a side BET, thus making it possible to entertainability of card games among the plurality of players.

A fourteenth aspect of the present invention is the game machine of the thirteenth aspect, further comprising the step of distributing and paying out a payment among all of the players having performed the side BET, in the step (g).

According to the game method set forth below, a card combination in which a payment is to be paid out in a side game is determined on a player-by-player basis, and a plurality of cards after dealt to the plurality of players are arranged in a state in which their kinds are identified. In a case where all of a plurality of cards after dealt to a plurality of players, which were displayed on the common display device, include a card combination in which a payment is to be paid out, the payment is distributed and paid out among the players having entered the side BETs. Therefore, in a case where a card combination “One Pair” or “Two Pairs” is determined on the display device when a side game is started, if five cards after dealt to all of the players include either of the card combinations “One Pair” and “Two Pairs”, the payment is distributed among the players having entered the side BETs, thus making it possible to enhance entertainability of card games among the plurality of players.

A fifteenth aspect of the present invention is the game method of the eleventh aspect, further including: the step of (h) determining a player to whom a payment is to be paid out, from among the plurality of players, wherein: the step (f) includes the step of paying out a payment to the player determined in the step (h).

According to the game method set forth below, a card combination in which a payment is to be paid out in a side game is determined on a player-by-player basis, and a plurality of cards after dealt to the plurality of players are arranged in a state in which their kinds are identified. In a case where all of a plurality of cards after dealt to a plurality of players, which were displayed on the common display device, include a card combination in which a payment is to be paid out, a player to whom a payment is to be paid out is determined from among the players having entered side BETs. Therefore, in a case where a card combination “One Pair” or “Two Pairs” is determined on the display device when a side game is started, for example, if five cards after dealt to all of the players include either of the card combinations “One Pair” and “Two Pairs”, a player to whom a payment is randomly paid out is determined from among the players having entered the side BETs, thus making it possible to enhance entertainability of card games among the plurality of players.

A sixteenth aspect of the present invention is a game method, including the steps of: (a) dealing to players a predetermined number of cards as players' cards and dealing to a banker a predetermined number of cards as banker's cards, in a basic game; (b) paying out to one of the players a payment determined by comparing the players' cards and the banker's cards, in the basic game; (c) determining a plurality of card combinations in which payments are to be paid out, from among plural kinds of cards, on a plural-players basis, according to a past game winner/loser log in, a side game; (d) dealing a plurality of cards to a plurality of players, respectively, from among plural kinds of cards, in the side game; (e) arranging a plurality of cards owned by the plurality of players in a state in which kinds of the plurality of cards are identified to the plurality of players, in the side game; and (f) paying out a payment to a player, based upon the card combinations in which payments are to be paid out determined in the step (c), in a case where the plurality of cards arranged on the player-by-player basis in the step (c) include the card combinations determined on the plural-players basis in the step (c).

According to the game method set forth below, a plurality of card combinations in which payments are to be paid out are determined depending upon the past win/loss in a side game. Therefore, in a case where a large number of accumulated BETs and a small number of wins take place, for example, a large number of card combinations in which payments are to be paid out is determined; and in a case where a small number of accumulated BETs and a large number of wins take place, a small number of card combinations in which payments are to be paid out are determined, thereby making it possible to enhance entertainability of card games.

A seventeenth aspect of the present invention is the game method of the sixteenth aspect, further including the step of (g) accepting a side BET that is different from a normal BET, wherein: the step (f) includes the step of paying out a payment to only at least one of the players having performed the side BET.

According to the game method set forth above, a card combination in which a payment is to be paid out in a side game is determined on a player-by-player basis, and a plurality of cards after dealt to a plurality of players are arranged in a state in which their kinds are identified. In a case where all of the plurality of cards after dealt to the plurality of players include a card combination in which a payment is to be paid out, a payment is paid out to only at least one of the players having entered a side BET. Therefore, in a case where a card combination “One Pair” or “Two Pairs” is determined on the display device when a side game is started, if five cards after dealt to all of the players include either of the card combinations “One Pair” and “Two Pairs”, a payment is paid out to only the player having entered the side BET, thus making it possible to enhance entertainability of card games among the plurality of players.

An eighteenth aspect of the present invention is the game method of the seventeenth aspect, wherein the step (f) includes the step of distributing and paying out a payment among all of the players having performed the side BET in the step (g).

According to the game method set forth below, a card combination in which a payment is to be paid out in a side game is determined on a player-by-player basis, and a plurality of cards after dealt to the plurality of players are arranged in a state in which their kinds are identified. In a case where all of a plurality of cards after dealt to a plurality of players, which were displayed on the common display device, include a card combination in which a payment is to be paid out, the payment is distributed and paid out among the players having entered the side BETs. Therefore, in a case where a card combination “One Pair” or “Two Pairs” is determined on the display device when a side game is started, if five cards after dealt to all of the players include either of the card combinations “One Pair” and “Two Pairs”, the payment is distributed among the players having entered the side BETs, thus making it possible to enhance entertainability of card games among the plurality of players.

A nineteenth aspect of the present invention is the game method of the seventeenth aspect, further including the step of (h) determining a player to whom a payment is to be paid out, from among the plurality of players, wherein: the step (f) comprises the step of paying out a payment to the player determined in the step (h).

According to the game method set forth below, a card combination in which a payment is to be paid out in a side game is determined on a player-by-player basis, and a plurality of cards after dealt to the plurality of players are arranged in a state in which their kinds are identified. In a case where all of a plurality of cards after dealt to a plurality of players, which were displayed on the common display device, include a card combination in which a payment is to be paid out, a player to whom a payment is to be paid out is determined from among the players having entered side BETs. Therefore, in a case where a card combination “One Pair” or “Two Pairs” is determined on the display device when a side game is started, a player to whom a payment is to be randomly paid out is determined from among the players having entered the side BETs, thus making it possible to enhance entertainability of card games among the plurality of players.

### BRIEF DESCRIPTION OF THE DRAWINGS

FIG. 1 is a view showing an exemplary image displayed on a front panel display device in a side game according to a first embodiment;

FIG. 2 is a perspective view schematically depicting a game machine according to a first embodiment;

FIG. 3 is a perspective view schematically depicting an appearance and configuration of stations included in the game machine shown in FIG. 2;

FIG. 4 is a view showing an exemplary image displayed on a front panel display included in the game machine according to the first embodiment;

FIG. 5 is a view showing an exemplary image displayed on a liquid crystal display included in each of the stations according to the first embodiment;

FIG. 6 is a block diagram depicting an internal configuration of the game machine shown in FIG. 2;

FIG. 7 is a block diagram depicting an internal configuration of the station included in the game machine shown in FIG. 2;

FIG. 8 is a view showing an exemplary image displayed on the front panel display of the game machine according to the first embodiment;

FIG. 9 is a view showing an exemplary combination payout table in the side game according to the first embodiment;

FIG. 10 is a view showing an exemplary card combination determination data table according to the first embodiment;

FIG. 11A is a view showing an exemplary image displayed on a liquid crystal display included in each of the stations while in a side game according to the first embodiment;

FIG. 11B is a view showing an exemplary image displayed on a liquid crystal display included in each of the stations while in a side game according to the first embodiment;

FIG. 12A is a view showing an exemplary image displayed on a liquid crystal display included in each of the stations while in a side game according to the first embodiment;

FIG. 12B is a view showing an exemplary image displayed on a liquid crystal display included in each of the stations while in a side game according to the first embodiment;

FIG. 13A is a view showing an exemplary image displayed on a liquid crystal display included in each of the stations while in a side game according to the first embodiment;

FIG. 13B is a view showing an exemplary image displayed on a liquid crystal display included in each of the stations while in a side game according to the first embodiment;

FIG. 14A is a flowchart showing main control unit processing executed at a main control unit included in the game machine according to the first embodiment;

FIG. 14B is a flowchart showing main control unit processing executed at a main control unit included in the game machine according to the first embodiment;

FIG. 15A is a flowchart showing a subroutine of station processing executed at the stations according to the first embodiment;

FIG. 15B is a flowchart showing a subroutine of station processing executed at the stations according to the first embodiment;

FIG. 16 is a view showing an exemplary image displayed on a front panel display device in a side game according to a second embodiment;

FIG. 17A is a flowchart showing main control unit processing executed at the main control unit included in a game machine according to the second embodiment; and

FIG. 17B is a flowchart showing main control unit processing executed at the main control unit included in the game machine according to the second embodiment.

### DESCRIPTION OF THE PREFERRED EMBODIMENTS

Hereinafter, a game machine 1 according to a first embodiment will be described in detail with referring to the drawings. The embodiments that follow describe in detail a case in which a payment is paid out according to a combination of cards after dealt to a plurality of players if a trigger for a side game is established according to a plural combinations of cards in a PAIGOW poker while in action.

First, the rules of the PAIGOW poker will be described in detail. In the PAIGOW poker of the embodiments, one or more players compete against a banker with the use of one set of trump cards (52 cards) excluding a joker.

Seven cards are dealt to each of the persons consisting of a banker and the players. Each of them divides seven cards into two groups of five cards and of two cards. At this time, a hand of five cards (a high hand) must be as strong as or must be stronger than that of two cards (a low hand).

Next, it is judged as to which one of the players' hands is strong or weak after comparing the five cards of each of the banker's and players' hands with each other. Similarly, it is judged as to which one of the players' hands is strong or weak after comparing the two cards of each of the banker's and players' hands with each other. In a case where the banker's hands are stronger in both of the two groups of five and two cards, it is judged to be the banker's win. In a case where one of the players' hands is stronger in both of the two groups of five and two cards, it is judged to be the player's win. In a case where the player's hands are stronger in one of the two groups consisting of five cards and two cards, and the banker's hand is stronger in the other one, it is judged to be “draw”. In addition, in a case where the player's hand and the banker's hand are identical to each other in strength with respect to both of the two groups of five and two cards, it is judged to be the banker's win.

The hands of five cards include “Royal Flush”, “Straight Flush”, “Four of a Kind”, “Full House”, “Straight”, “Three of a Kind”, “Two of a Kind”, and “No Pair” in order of strength. The hands of two cards include “One Pair” and “No Pair” in order of strength.

In addition, in a case where the player's and banker's hands are identical to each other, it is judged as to which one of the players' hands is strong or weak after comparing the numbers or alphabets drawn in cards constituting the hands with each other. The card's numbers and alphabets include “A”, “K”, “Q”, “J”, “10”, “9”, “8”, “7”, “6”, “5”,“4”, “3”, and “2” in sequential order from the strongest combination of the five cards.

In the embodiments that follow, a PAIGOW poker accepting a normal BET and a side BET is executed. The normal BET is to be performed for the play of the PAIGOW poker, and the side BET is stored in an accumulative manner as a jackpot (hereinafter, referred to as a JP) at a predetermined rate included in a betted currency value (50% in the embodiments of the present invention). The following embodiments describe a case in which a dealer takes over a banker.

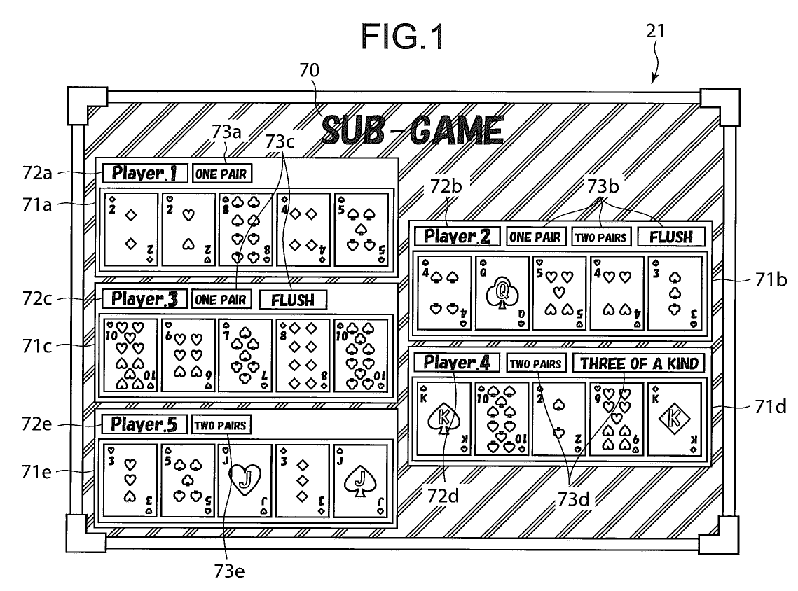

FIG. 1 is a view showing an exemplary image displayed on a front panel display in a side game according to a first embodiment. As shown in FIG. 1, a sub-game is started, a front panel display 21 displays a sub-game display image 70 indicating that the sub-game is started. Further, this front panel display displays, on a player-by-player basis, one or plural sub-game card combination display images 73a to 73e indicating that a payment is paid out. These images are displayed from card combinations “Royal Flush”, “Straight Flush”, “Four of a Kind”, “Full House”, “Flush”, “Straight”, “Three of a Kind”, “Two Pairs”, and “One Pair”. As winning card combinations in which payments are paid out, “One Pair” is determined for a player 1; “One Pair”, “Two Pairs”, and “Flush” for a player 2; “One Pair” and “Flush” for a player 3; “Two Pairs” and “Three of a Kind” for a player 4; and “Two Pairs” for a player 5; and sub-game card combination image displays 73a to 73e are displayed.

When the side-game card combination display image 70 is displayed, five cards are dealt to each of a plurality of players, and then, the dealt cards are displayed as the players' cards on the front panel display 21. Here, card images 71a to 71e after dealt to players 1 to 5, respectively, are displayed, and player displays 72a to 72c are displayed indicating that five players 1 to 5 are performing a sub-game. In a case where all of the five cards after dealt to each of the players includes a sub-game card combination displayed on the player-by-player basis, a payment is paid out, based upon the display sub-game card combination. Here, since all of the cards after dealt to each of the players 1 to 5 include a card combination “One Pair”, a payment is paid out based upon such combination “One Pair”.

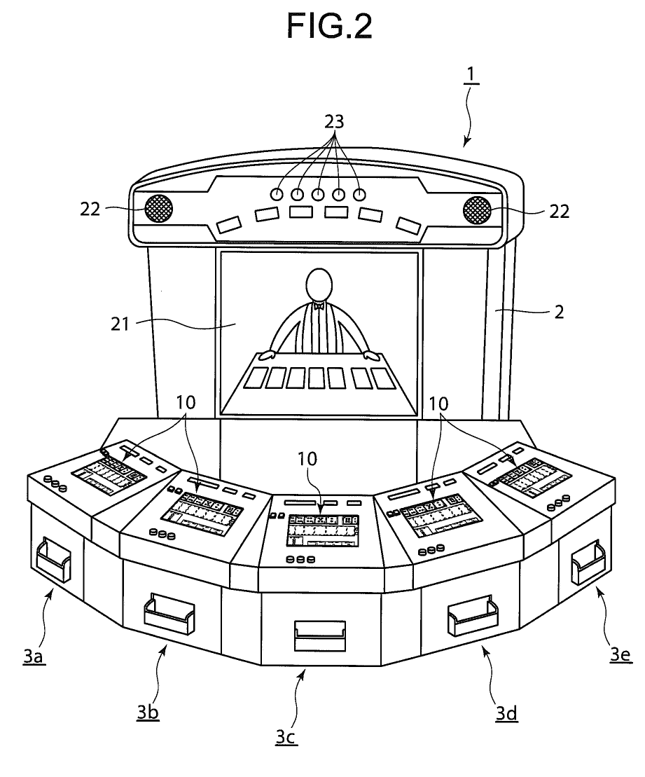

FIG. 2 is a perspective view schematically depicting an appearance and a configuration of a game machine according to a first embodiment of the present invention. As shown in FIG. 2, the game machine 1 is basically made up of a main monitor 2 and five stations 3 (stations 3a to 3e ). While the present embodiment describes in detail a case in which the game machine 1 is provided with a plurality of stations 3 (five stations), the game machine may include over five stations in the present invention.

A front panel display 21 is provided at the center part of a main monitor 2, and an image indicative of a dealer and cards is displayed. The front panel display 21 is equivalent to a display device of the present invention. In addition, provided at the upper side of the main monitor 2 are: a speaker 22 for outputting music or effect sounds in accordance with the progress of a game executed by the game machine 1; and an LED23 that is lit at the time of various effects.

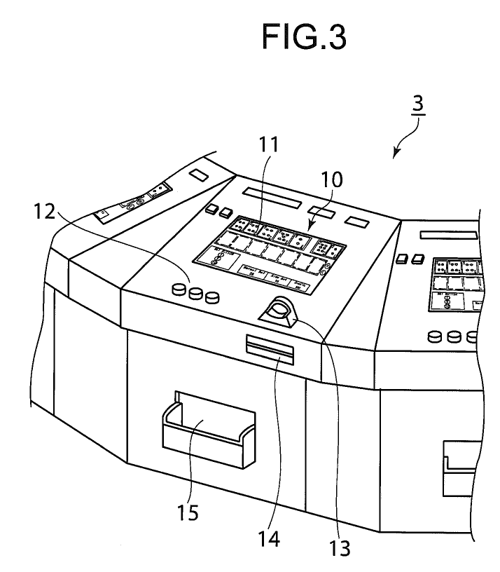

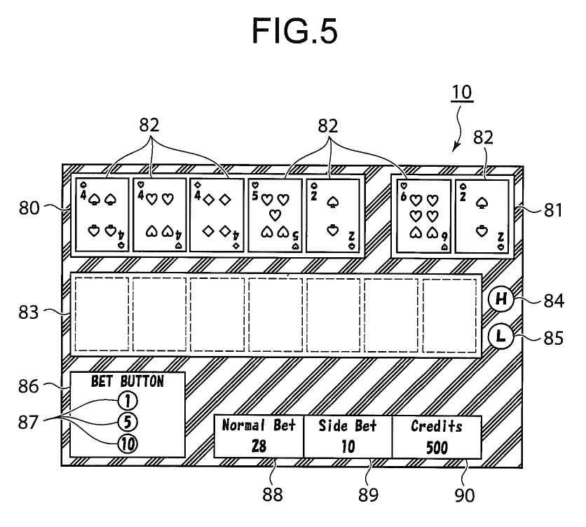

FIG. 3 is a perspective view schematically depicting an appearance and a configuration of stations included in the game machine shown in FIG. 2. As shown in FIG. 3, a liquid crystal display 10, which displays an image or the like pertinent to operation (see FIG. 5), as described later, is provided at the upper center of a station 3. In addition, a touch panel 11 for entering an operation such as BET is provided on the top face of the liquid crystal display 10. The touch panel is equivalent to a BET switch, a side-BET switch, and an input switch, of the present invention.

An operational button 12 for making payout operation and a coin insertion slot 13 for inserting coins or medals are provided in front of the liquid crystal display 10. A bill insertion slot 14 for inserting bills is provided at the front top right end of the station 3. Provided downwardly of the bill insertion slot 14 is a coin payout opening 15 through which the coins or medals corresponding to stored credit are paid out to the players when payout operation is made.

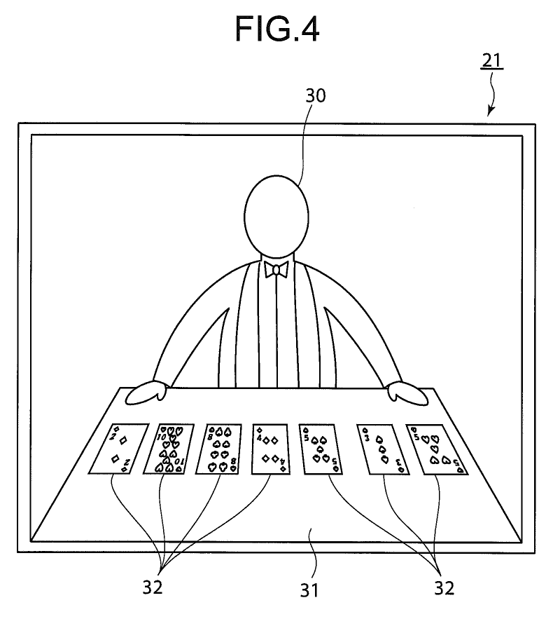

FIG. 4 is a view showing an exemplary image displayed on a front panel display included in a game machine. As shown in FIG. 4, the front panel display 21 displays a dealer image 30 indicating a dealer (banker), a table image 31 indicative of a table, and a card image 32 indicative of seven banker's cards. The card image 32 is displayed in a faced down manner when cards are dealt to the dealer. When a high hand and a low hand are determined, the card image 32 is displayed in a faced up manner. In FIG. 4, the left five cards toward the dealer indicate a high hand, and the right two cards indicate a low hand.

FIG. 5 is a view showing an exemplary image displayed on a liquid crystal display included in stations. As shown in FIG. 5, a high hand display section 80, which displays a player's high hand, and a low hand display section 81, which displays a low hand, are provided at the upper side of the liquid crystal display 10. The high hand display section 80 and the low hand display section 81 display card images 82 indicative of a high hand card and a low hand card, respectively, in a faced up manner.

A dealt-card display section 83 is provided at the lower side of the high hand display section 80. A card image indicative of the seven player's cards after dealt to each of the players is displayed in a faced up manner at seven portions enclosed by the dotted line of the dealt-card display section 83. A high hand determination button 84 and a low hand determination button 85, for determining cards constituting a high hand and a low hand, are provided at the right side of the dealt-card display section 83. A player can determine a high hand by selecting a card desired to be high hand, via a touch panel 11, from among the cards displayed at the dealt-card display section 83, and then, operating the high hand determination button 84. The card determined to be a high hand is displayed at the high hand display section 80. Similarly, the player determines a low hand by selecting a card desired to be a low hand, via the touch panel 11, from among the cards displayed at the dealt-card display section 83, followed by operating a low hand determination button 85 via the touch panel 11.

A BET button display section 86 is provided at the lower side of the dealt-card display section 83. The BET button display section 86 displays a BET button 87 for inputting a BET number. The player can input a normal BET number and a side BET number by operating a BET button 87 via the touch panel 11.

A normal BET number display section 88, which displays the number of normally betted coins, is provided at the right side of the BET button display section 86. It is shown here that 28 coins have been betted. In a case where betting of these 28 coins is input, the player may operate “10” of the BET button 87 twice, “5” of the BET button 87 once, and “1” of the BET button 87 three times.

A side-BET number display section 89, which displays the number of side-betted coins, is provided at the right side of the normal BET number display section 88. Here, it is shown that 10 coins have been betted. Further, a credit number display section 90 is provided at the right side of the side-BET number display section 89. Here, it is shown that 500 coins have been credited.

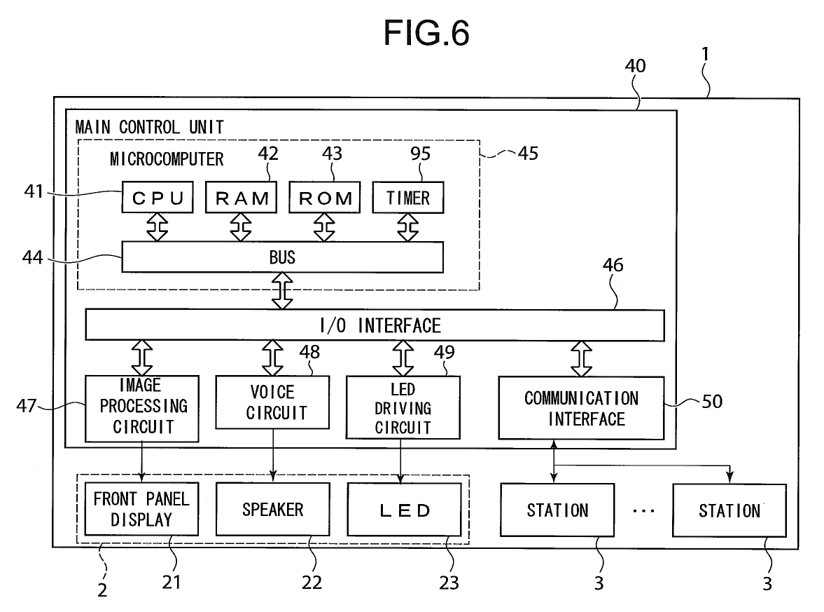

FIG. 6 is a block diagram depicting an internal configuration of the game machine shown in FIG. 2. As shown in FIG. 6, a main control unit 40 included in the game machine 1 is basically constituted while a microcomputer 45 made up of: a CPU (Central Processing Unit) 41; a RAM (Random Access Memory) 42; a ROM (Read Only Memory) 43; a timer 95; and a bus 44 for transferring data therebetween is employed as a base. The main control unit 40 is equivalent to a controller of the present invention.

The ROM43 stores: various programs for performing processing required for controlling the game machine 1; and a data table or the like. The RAM42 is a memory for temporarily storing various data computed by the CPU41. Further, the timer 95 performs time measurement.

The CPU41 is connected via an I/O interface 46 to an image processing circuit 47, a voice circuit 48, an LED driving circuit 49, and a communication interface 50.

A front panel display 21 constituting a main monitor 2 is connected to the image processing circuit 47; a speaker 22 constituting the main monitor 2 is connected to the voice circuit 48; and an LED23 constituting the main monitor 2 is connected to the LED driving circuit 49. Five stations 3 are connected to the communication interface 50.

The CPU41 controls games (a PAIGOW poker and a side game) to be conducted in the game machine 1, based upon game programs (a PAIGOW poker game program and a side-game program) stored in the ROM43 and various signals received from the stations 3. Further, the CPU41 controls the front panel display 21 to display images, the speaker 22 to output sounds, and the LED23 to light, based upon the game programs. Furthermore, the CPU41 transmits various signals to the stations 3, based upon the above-mentioned game programs.

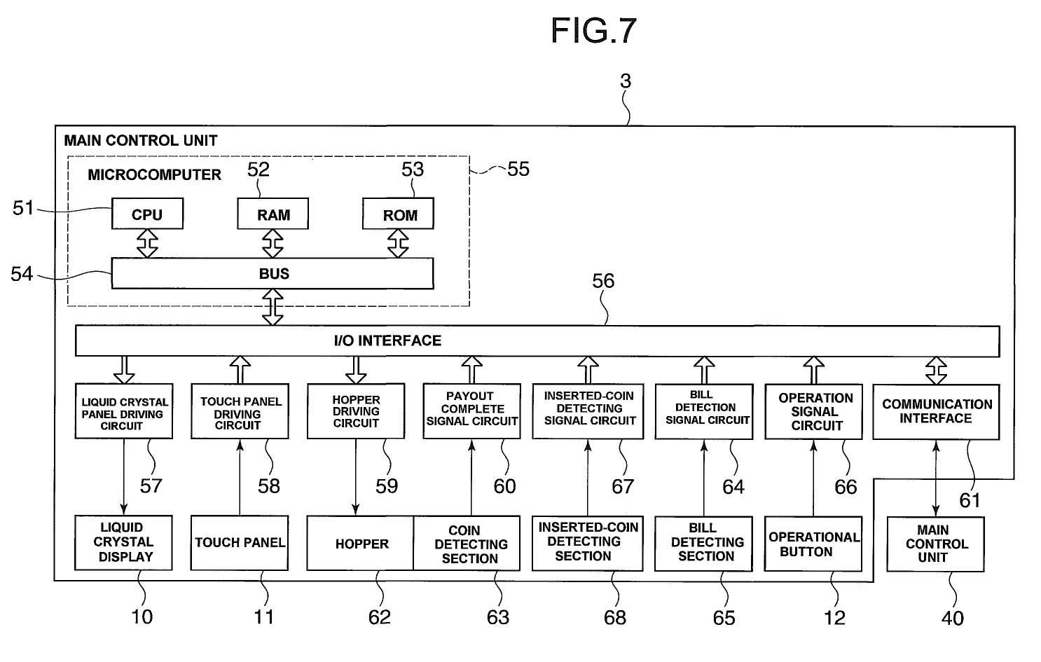

FIG. 7 is a block diagram depicting an internal configuration of each of the stations included in the game machine shown in FIG. 2. As shown in FIG. 7, stations 3 are basically constituted while microcomputers 55 made up of a CPU51, a RAM52, a ROM53, and a bus 54 for transferring data therebetween are employed as a base.

The ROM53 stores a variety of programs and data tables or the like, for performing processing required for controlling stations 3. In addition, the RAM52 temporarily stores the credit number currently stored in stations 3 and a variety of data computed by the CPU51.

In addition, the CPU51 is connected, via an I/O interface 56, to a liquid crystal panel driving circuit 57; a touch panel driving circuit 58; a hopper driving circuit 59; a payout complete signal circuit 60; an inserted-coin detection signal circuit 67; a bill detection signal circuit 64; an operation signal circuit 66; and a communication interface 61.

The liquid crystal display 10 is connected to the liquid crystal panel driving circuit 57; the touch panel 11 is connected to the touch panel driving circuit 58; a hopper 62 is connected to a hopper driving circuit 59; a coin detecting section 63 is connected to the payout complete signal circuit 60; an inserted-coin detecting section 68 is connected to the inserted-coin detection signal circuit 67; a bill detecting section 65 is connected to the bill detection signal circuit 64; and the operational button 12 is connected to the operation signal circuit 66, respectively.

The hopper 62 serves to pay out coins from the coin payout opening 15, based upon a control signal output from the CPU51. The coin detecting section 63 is provided inside the coin payout opening 15, and transmits signals to the CPU51 in a case where it is detected that a predetermined number of coins have been paid out from the coin payout opening 15.

Upon detecting that coins have been inserted through the coin insertion slot 13, the inserted-coin detecting section 68 detects the amount of the detected coins, and then, transmits to the CPU51 a detection signal indicative of the detected amount. The detected coins are stored in the RAM52 while a predetermined amount is handled as one credit.

At the time of acceptance of bills, the bill detecting section 65 detects the amount of the accepted bills, and then, transmits to the CPU51 a detection signal indicating the detected amount. The detected bills are stored in the RAM52 while the predetermined amount is handled as one credit. The operation button 12 is intended for performing payout operation in a case where coin payout has been determined.

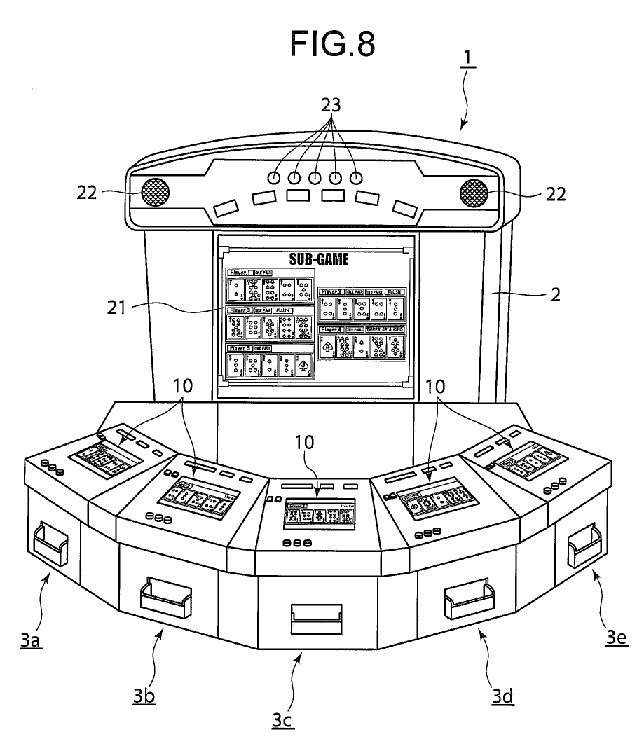

FIG. 8 is a view showing an exemplary image displayed on the front panel display of the game machine according to the first embodiment. As shown in FIG. 8, the game machine 1 is made up of a main monitor 2 and five stations 3 (3a to 3e ). When a side game is started, the display device 21 at the center of the main monitor 2 and the liquid crystal display 10 display one or more sub-game card combination display images 73a to 73e indicating that a payment is paid out. These images are displayed on a player-by-player basis from among card combinations “Royal Flush”, “Straight Flush”, “Four of a Kind”, “Full House”, “Flush”, “Straight”, “Three of a Kind”, “Two Pairs”, and “One Pair”. Further, the front panel display 21 and the liquid crystal display 10 display side game dealt-cards after dealt to players of the respective stations 3 (3a to 3e ). In a case where all of the cards after dealt on the player-by-player basis, which were displayed on the front panel display 21 and the liquid crystal display 10, includes a sub-game card combination displayed on the player-by-player basis, a payment is paid out to players of the stations 3 (3a to 3e ), based upon the displayed sub-game card combination.

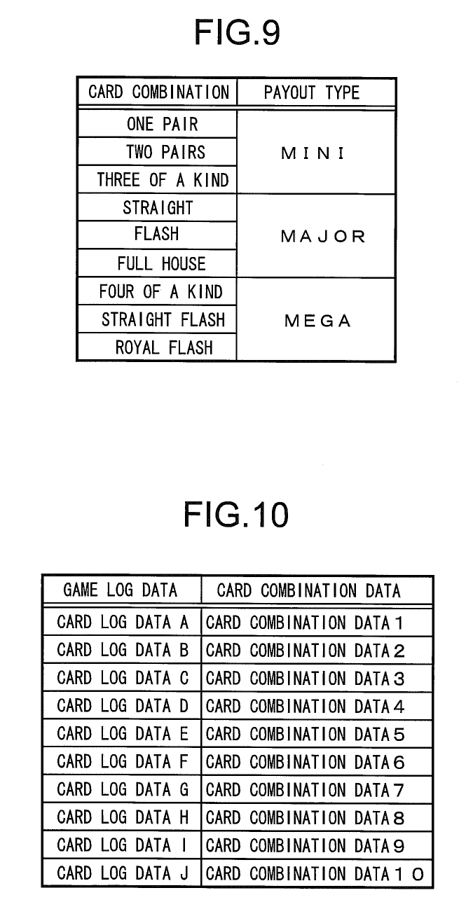

FIG. 9 is a view showing an exemplary combination payout determination table in the side game according to the first embodiment. The combination payout table is stored in the ROM43 while various combinations and payout types are associated with each other. As shown in FIG. 9, in the case of a card combination in which the cards after dealt in the side game were determined, the payout type of payment is determined based upon the determined combination. Where a card combination of the dealt cards is “One Pair”, “Two Pairs”, or “Three of a Kind”, a payment corresponding to “MINI” is determined; where it is “Straight”, “Flush”, or “Full House”, a payment corresponding to “MAJOR” is determined; or where it is “Four of a Kind”, “Straight Flush”, or “Royal Flush”, a payment corresponding to “MEGA” is determined. In other words, credit is paid out based upon the determined payout type.

FIG. 10 is a view showing an exemplary card combination determination data table according to the first embodiment. The card combination determination data table is stored in ROM43 while game historical data determined based upon the past winner-loser data is associated with kinds of card combinations in which payments in a side game are to be paid out. As shown in FIG. 10, with referring to the card combination determination data table, a card combination in which a payment is to be paid out in the side game is determined, depending upon the past game winner-loser data accumulatively stored in the RAM52. In a case where the past game winner-loser log includes a plenty of losers, “card combination data 10” corresponding to “game historical data J” is determined, and a poker combination is determined so as to increase kinds of card combinations in which payments are to be paid out. In a case where the past game winner-loser log includes a plenty of winners, “card combination data 1” corresponding to “game historical data A” is determined, and then, a poker combination is determined so as to decrease kinds of card combinations in which payments are to be paid out.

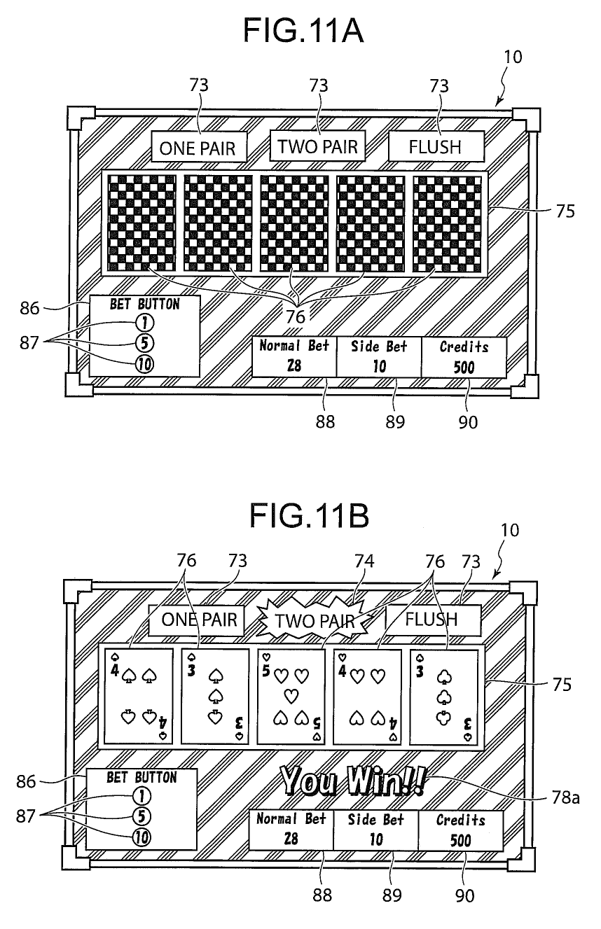

FIGS. 11A and 11B are views each showing an exemplary image displayed on the liquid crystal display included in each of the stations in a side game according to the first embodiment. As shown in FIG. 11A, when a side game is started, the liquid crystal display 10 displays, on the player-by-player basis, one or more sub-game card combination display images 73 indicating that a payment is paid out. The images are displayed, according to the past game winner-loser data, from among card combinations “Royal Flush”, “Straight Flush”, “Four of a Kind”, “Full House”, “Flush”, “Straight”, “Three of a Kind”, “Two Pairs”, and “One Pair”. Here, three card game combination display images 73 indicative of “One Pair”, “Two Pairs”, and “Flush” are displayed according to the past game winner-loser data. Then, side game cards 76 after dealt when the side game is started are displayed in a faced down state at the side game dealt-card display section 75.

A BET button display section 86 is provided at the lower side of a side game dealt-card display section 83. A normal-BET number display section 88, a side-BET number display section 89 for displaying the number of side-betted coins, and a credit amount display section 90 are provided at the lower side of a side game dealt-card display 75. Here, 28 coins are normally betted, 10 coins are side-betted, and 500 coins are credited.

As shown in FIG. 11B, the liquid crystal display 10 displays, at the side game dealt-card display section 75, in a faced up state, the faced down side-game cards 76 that were dealt when the side game is started in FIG. 11A. Further, winner-loser information display 78 is displayed according to the sub-game card combination display image 73 indicating that a payment is paid out and a combination of cards displayed at the side game dealt-card display section 75. Here, five dealt side-game cards 76, i.e., “4 of Spade”, “3 of Spade”, “5 of Heart”, “4 of Heart”, and “3 of Clover” are displayed. Among the sub-game card combination display image 73 indicating that a card combination displayed at the side game dealt-card display section 75 is “One Pair”, “Two Pairs”, or “Flush” in which a payment is to be paid out, all of plural cards displayed on the player-by-player basis include a card combination display image 74. Therefore, a winner-loser information display 78a , which is inclusive of a message “You Win”, is displayed; a payment corresponding to “MINI” is determined; and then, credit is paid out, based upon the determined payout type (see FIG. 9).

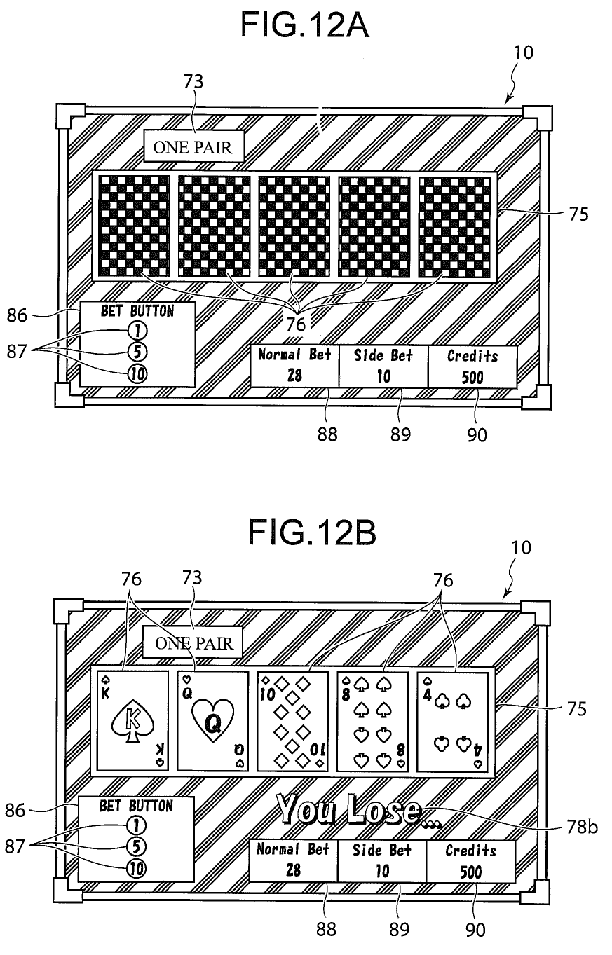

FIGS. 12A and 12B are views each showing an exemplary image displayed on the liquid crystal display included in each of the stations in a side game according to the first embodiment. As shown in FIG. 12A, when a side game is started, the liquid crystal display 10 displays one or more sub-game card combination display images 73 indicating that a payment is paid out. These images are displayed according to the past game winner-loser data from among card combinations “Royal Flush”, “Straight Flush”, “Four of a Kind”, “Full House”, “Flush”, “Straight”, “Three of a Kind”, “Two Pairs”, and “One Pair”. Here, since the past winner-loser log includes a plenty of winners, one sub-game combination display image 73 indicative of “One Pair” is displayed, and the side game dealt-card display section 75 displays, in a faced down state, the side-game cards 76 that were dealt when a side game is started.

As shown in FIG. 12B, the liquid crystal display 10 displays, at the side-game dealt-card display section 75, in a faced up state, the faced-down side-game cards 76 that were dealt when a side game is started in FIG. 12A. Further, winner-loser information display 78 is displayed according to: the side-game card combination display image 73 indicating that a payment is paid out; and a card combination displayed at the side game dealt-card display section 75. Here, five side-game cards 76, i.e., “King of Spade”, “Queen of Spade”, “10 of Diamond”, “8 of Spade”, and “4 of Clover” are displayed. Card combinations displayed at the side game dealt-card display section 75 do not include a card combination “One Pair” in which a payment is to be paid out to all of the cards displayed on the player-by-player basis. Therefore, the winner-loser information display 78b , which is inclusive of a message “You Lose”, is displayed.

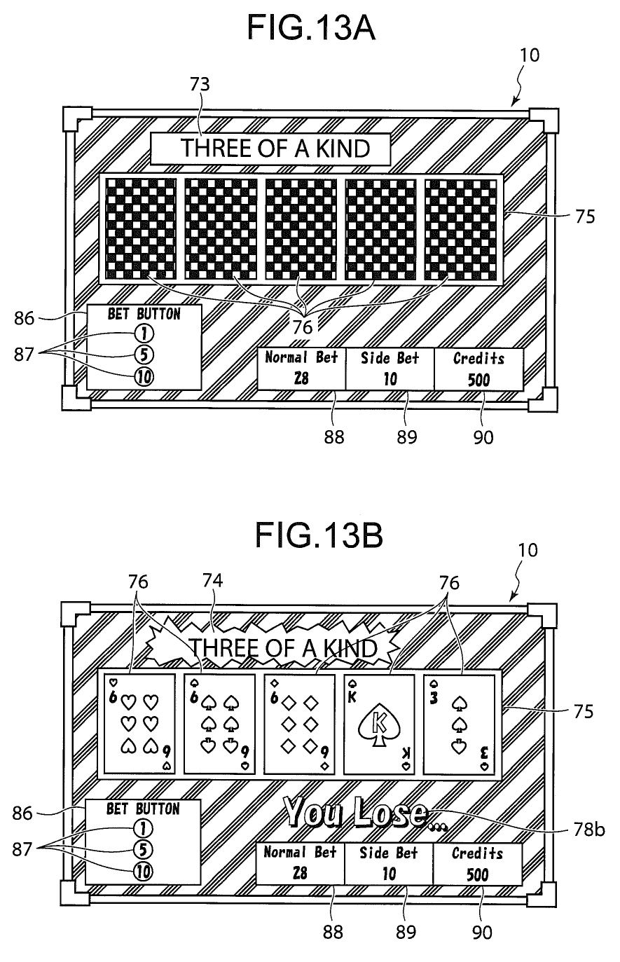

FIGS. 13A and 13B are views each showing an exemplary image displayed on the liquid crystal display included in each of the stations in a side game according to the first embodiment. As shown in FIG. 13A, when a side game is started, the liquid crystal display 10 displays one or more sub-game card combination display images 73 indicating that a payment is paid out. The images are displayed according to the past game winner-loser data from among card combinations “Royal Flush”, “Straight Flush”, “Four of a Kind”, “Full House”, “Flush”, “Straight”, “Three of a Kind”, “Two Pairs”, and “One Pair”. Here, since the past winner-loser log includes a plenty of winners, one sub-game combination display image 73, which is indicative of “One Pair”, is displayed. Further, the side game dealt-card display section 75 displays, in a faced down state, the side-game cards 76 that were dealt when the side game is started.

As shown in FIG. 13B, the liquid crystal display 10 displays at the side-game dealt-card display section 75, in a faced up state, the faced-down side-game cards 76 that were dealt when a side game is started in FIG. 13A. Further, the winner-loser information display 78 is displayed according to the side-game card combination display image 73 indicating that a payment is paid out and a card combination displayed at the side game dealt-card display section 75. Here, five side-game cards 76, i.e., “4 of Spade”, “6 of Heart”, “6 of Diamond”, “King of Clover”, and “3 of Spade” are displayed, and then, the card combination displayed at the side game dealt-card display section 75 includes a combination display image 74 indicative of “Three of a Kind”, whereas a combination of cards “Three of a Kind” displayed for another player is not included. Therefore, the winner-loser information display 78b , which is inclusive of a message “You Lose”, is displayed.

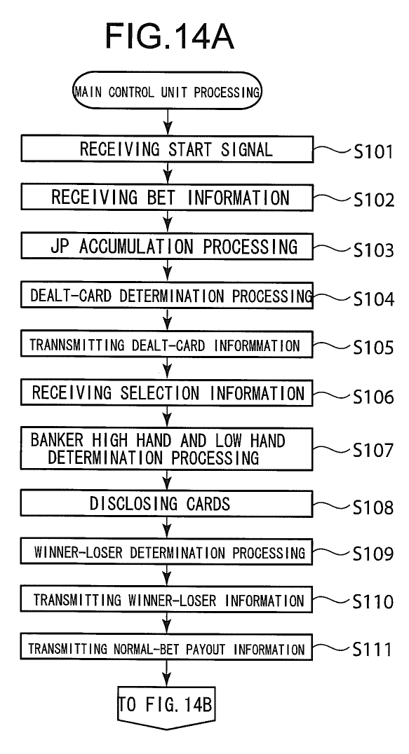

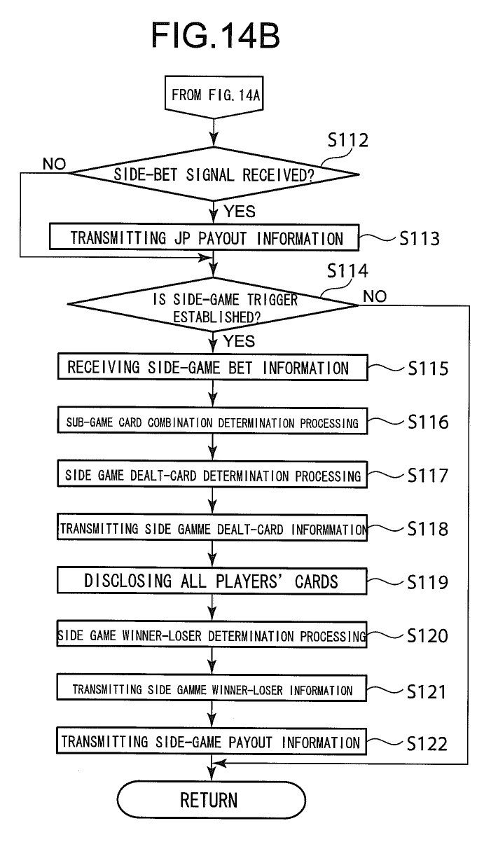

Next, the processing to be performed at the main control unit 40 and stations 3 will be described in detail. FIG. 14A and FIG. 14B are flowcharts each showing main control unit processing to be executed at the main control unit included in the game machine according to the first embodiment. In this processing operation, at first, the CPU41 included in the main control unit 40 receives a start signal (step S101). Specifically, the CPU41 receives the start signal from any of the stations 3. The start signal serves as a trigger for conducting a PAIGOW poker game in the game machine 1.

Next, the CPU41 receives BET information from the stations 3 (see FIG. 2) (step S102). The BET information is pertinent to BETs, and includes: information indicative of whether or not a normal BET and a side BET have been performed; and information indicative of the amounts of the normal BET and the side BET.

Next, the CPU41 executes JP accumulation processing (step S103). Specifically, the CPU41 accumulatively stores, in the RAM42 (see FIG. 6), 50% (predetermined rate) of the side-betted credit as JP, based upon the BET information received at step S102.

Next, the CPU41 executes dealt-card determination processing (step S104). In this processing operation, the CPU41 determines seven cards to be dealt to each of the persons consisting of the players and banker from among one set of trump cards, with the use of random numbers. The seven cards determined to be dealt to the players at the step S104 are equivalent to the player's cards, and the seven cards determined to be dealt to the banker are equivalent to the banker's cards. Further, the front panel display 21 (see FIG. 2) included in the game machine 1 displays a card image indicative of the seven banker's cards in a faced down manner.

Next, the CPU41 transmits dealt-card information (step S105). Specifically, the CPU41 transmits the dealt-card information to stations 3. The dealt-card information includes the one which is indicative of the kinds of cards (suits (heart, clover, spade, and diamond)) that were determined to be dealt to the players and banker. At each of the stations 3, the liquid crystal display 10 displays the card image indicative of the seven player's cards, based upon the received dealt-card information, and then, accepts entry for dividing them into a group of 5 cards (high hand) and a group of two cards (low hand).

Next, the CPU41 receives selection information from the station 3 (step S106). The selection information indicates which ones of the cards after dealt to each of the players have been selected as a high hand, and which ones of the cards have been selected as a low hand.

Next, the CPU41 executes processing of determining a banker's high hand and low hand (step S107). In this processing operation, the CPU41 executes processing of dividing the cards after dealt to the banker into a high hand and a low hand.

Next, the CPU41 discloses cards (step S108). Specifically, the CPU41 displays in a faced up manner on the front panel display 21 the card images indicative of the high hand and the low hand determined at the step S106.

Next, the CPU41 performs winner-loser determination processing (step S109). In this processing operation, the CPU41 executes processing of determining a winner or loser, based upon the selection information received at the step S106 and the high hand and the low hand determined at step S107. Namely, this CPU executes processing of determining a winner or loser after comparing the players' hands of the cards after dealt to the players and the banker's card hands. Specifically, it is judged as to which one of the players' hands is strong or weak after comparing the players' high hands with the banker's high hand. In addition, it is also judged as to which one is strong or weak after comparing the players' low hands with the banker's low hand. Further, the winner or loser is determined based upon the judgment results. Specifically, in a case where the player's high hand is stronger than the banker's high hand and in a case where the player's low hand is stronger than the banker's low hand, it is judged to be the player's win. In a case where the banker's high hand is stronger than the player's high hand and in a case where the banker's low hand is stronger than the player's low hand, it is judged to be the banker's win. Even if the player is stronger at one of the high and low hands, in a case where the banker is stronger at the other one, it is judged to be “draw”.

Next, the CPU41 transmits winner-loser information (step S110). Specifically, the CPU41 transmits to the station 3 the information indicative of the winner or loser determined at the step S109 (hereinafter, referred to as winner-loser information). Upon the receipt of the winner-loser information, based upon the received winner-loser information, the liquid crystal display 10 displays any one of the images inclusive of the messages “You Win”, “You Lose”, and “Draw”.

Next, the CPU41 performs processing of transmitting normal-BET payout information (step S111). In this processing operation, the CPU41 transmits the normal-BET payout information to the station 3. The normal-BET payout information is generally indicative of the amount of credit (currency values) to be paid out to BET. Specifically, in a case where the player has won, this CPU transmits information indicative of credit of which amount is twice of that of normal BET. In a case where the outcome of the game is “draw”, the CPU transmits information indicative of credit of which amount is equal to that of normal BET. In addition, in a case where the banker has won, the CPU transmits information indicative of the fact that an amount of given credit is 0.

Next, in FIG. 11B, the CPU41 judges whether or not a side BET signal has been received (step S112). Specifically, the CPU41 judges whether or not a signal has been received indicative of the fact that the side BET has been performed. When the CPU41 judges that no side BET signal has been received (step S112: NO), the routine proceeds to step S113.

On the other hand, when it is judged that a side BET signal is received (step S112: YES), JP payout information is transmitted to the station 3 (step S113). The JP payout information is indicative of the amount of JP credit (currency value) to be paid out to the side BET. Specifically, in a case where the player has won, when a high hand is “Royal Flush”, the CPU41 transmits information indicative of credit equivalent to a total amount of JP. When the player's high hand is “Straight Flush”, this CPU transmits information indicative of credit equivalent to 50% of JP, and when the player's high hand is a hand other than the above, this CPU transmits information indicative of a credit equivalent to 10% of JP. In addition, in a case where the result is “draw”, this CPU transmits information indicative of a credit of which amount is equal to that of a side BET. Moreover, in a case where the banker has won, this CPU transmits the fact that the amount of credit given is 0.

While the embodiment of the present invention describes a case in which, when the player has won in a PAIGOW poker at the time of side BET, where the high hand is “Royal Flush”, 100% of JP is given, where the high hand is “Straight Flush”, 50% of JP is given, and where the high hand is a hand other than the above, 10% of JP is given. In the embodiment of the present invention, a correspondence relationship between the amount of JP given and a hand is not limitative thereto. In the present invention, further, in a case where the player has won in the PAIGOW poker at the time of side BET, all of the currency values accumulatively stored as JP may be given, regardless of the hand.

The embodiment of the present invention described a case in which a correspondence relationship between a player's hand and a payment (JP) to be paid out, in the PAIGOW poker at the time of side BET is preset. In the present invention, however, the correspondence relationship between the player's hand and the payment to be paid out may be randomly varied every time the PAIGOW poker is performed at the time of a side BET.

Further, while the embodiment of the present invention describes a case of paying out credit of which amount is equal to that of side BET in a case where the result is “draw”, the above payout of the credit may not be performed.

Next, the CPU41 judges whether or not a side game trigger is established (step S114). Specifically, the CPU41 executes the programs stored in the RAM42, thereby sampling random number values from among the numeric range of predetermined random number values and judging whether or not a side game trigger is established based upon the sampled random number values. The CPU41 terminates main control unit processing when it executes the processing of step S114 upon judging that a side game trigger has not been established (step S114: NO). In another embodiment of the present invention, further, judgment of whether or not a side game trigger is established is made based upon whether or not a side BET has been performed in advance.

On the other hand, upon judging that a side-game trigger has been established (step S114: YES), the CPU41 receives side-game BET information from the station 3 (see FIG. 2) (step S115). BET information is pertinent to BETs, and includes information indicative of whether or not normal BET and side BET have been performed or information indicative of the amounts of the normal BET and side BET.

Next, the CPU41 executes processing of determining a side-game card combination (step S116). In this processing operation, the CPU41 determines, on the player-by-player basis, one card combination from among one or more sub-game card combinations in which payments are to be paid out. This determination is made according to the past game winner-loser data, from among card combinations “Royal Flush”, “Straight Flush”, “Four of a Kind”, “Full House”, “Flush”, “Straight”, “Three of a Kind”, “Two Pairs”, and “One Pair”.

Next, the CPU41 executes processing of determining cards after dealt in a side game (step S117). In this processing operation, the CPU41 determines five cards after dealt to the players, from one or plural groups of trump cards, with the use of random numbers.

Next, the CPU41 transmits information on cards to be dealt in the side game (step S118). Specifically, the CPU41 transmits, to the station 3, information on cards after dealt in the side game. The side game dealt-card information includes information indicative of suits (heart, club, spade, and diamond) of the cards determined to be dealt to the players. At the station 3, based upon the received dealt-card information, the liquid crystal display 10 displays a card image indicative of the five player's cards.

Next, the CPU41 discloses all of the player's cards (step S119). Specifically, the CPU41 displays, in a faced up manner on the front panel display 21 on a player-by-player basis, the five-card images of the players' cards determined at step S117 (see FIG. 1). In this case, the player can view the cards that were placed and arranged.

Next, the CPU41 performs side game winner-loser determination processing (step S120). In this processing operation, the CPU41 executes winner-loser determination processing, based upon the side-game cards of all the players disclosed at step S119. Specifically, the CPU41 judges whether to include the side-game card combination determined at step S116 and the card combination in which a payment is to be paid out to all of the cards displayed on the player-by-player basis. Then, based upon the judgment result, this CPU determines the winner or loser.

Next, the CPU41 transmits side game winner-loser information (step S121). Specifically, the CPU41 transmits to a station 3 the winner-loser information indicative of a winner or loser of the side game determined at step S120. The station 3 displays any one of the images inclusive of the messages “You Win”, “You Lose”, and “Draw” on the liquid crystal display 10, based upon winner-loser information, upon the receipt of the winner-loser information (see FIGS. 11, 12, and 13).

Next, the CPU41 transmits side-game payout information to the stations 3 (step S123). The side-game payout information is indicative of the amount of credit (currency value) to be paid out to the side game. Specifically, in a case where all of the cards displayed on the player-by-player basis include the side-bet card combinations determined at step S116, this CPU determines the payout types corresponding to the card combinations (see FIG. 9), and then, transmits information indicative of the determined credit. When executing the processing at step S122, the CPU41 terminates main control unit processing.

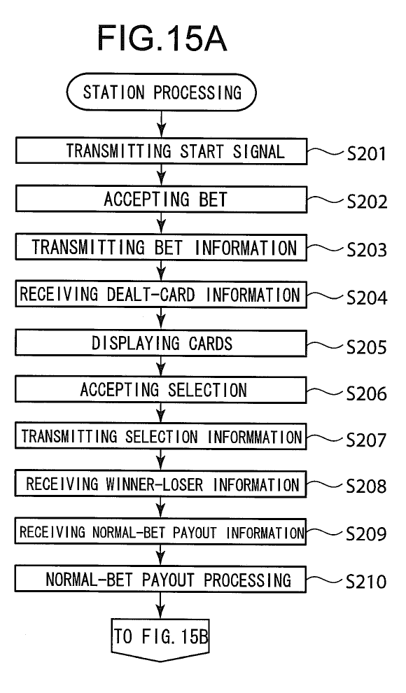

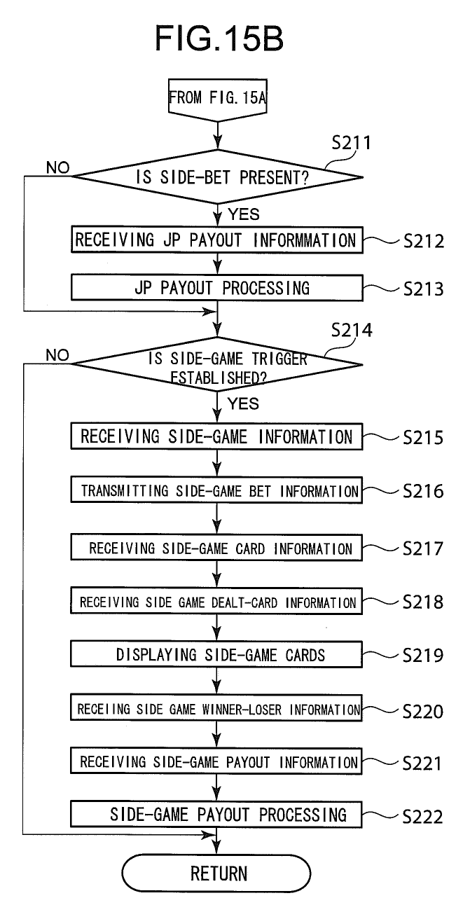

Next, the processing to be performed at the station 3 will be described in detail. FIGS. 15A and 15B are flowcharts each showing a subroutine of the station processing executed at each of the stations according to the first embodiment. In this processing operation, at first, the CPU51 included in the station 3 transmits a start signal to the main control unit 40d upon the receipt of signal indicative of the fact that a touch from the touch panel 11 has been sensed or that coin insertion has been detected from the inserted-coin detecting section 68 (step S201). In this manner, at the main control unit 40, the processing operations shown in FIGS. 11A and 11B are conducted.

Next, the CPU51 accepts entries of the normal BET and side BET (step S202). This allows the player to enter the normal BET and the side BET via the touch panel 11 included in the station 3. Upon the receipt of a signal indicative of the fact that entry of the side BET has been made, the CPU51 sets a side-BET flag. This side-BET flag is set in a case where entry of the side BET has been made.

Next, the CPU51 transmits to the main control unit 40, BET information serving as information pertinent to an input BET (step S203). Upon the receipt of the BET information, the main control unit 40 determines cards to be dealt to the players and the banker (see step S104 of FIG. 14A).

Next, the CPU51 receives from the main control unit 40 the dealt-card information indicative of the cards after dealt to the players (step S204). Specifically, the CPU51 receives the dealt-card information transmitted at step S105 of FIG. 11A, and then, stores the received information in a RAM.

Next, the CPU51 displays cards (step S205). Specifically, the CPU51 displays a card image indicative of the seven player's cards at the dealt-card display section 83 of the liquid crystal display 10, based upon the dealt-card information received at step S204.

Next, the CPU51 accepts entry for selecting high hands and low hands (step S206). This allows the players to determine high hands and low hands from among the dealt cards by operating a high hand determination button 84 and a low hand determination button 85 via the touch panel 11.

Next, the CPU51 transmits to the main control unit 40 the selection information that is based upon selection of high hands and low hands (step S207). Upon the receipt of the selection information, the main control unit 40 determines a high hand and a low hand of the banker's cards, and then, executes processing of determining a winner or loser (see step S109 of FIG. 14A).

Next, the CPU51 receives winner-loser information from the main control unit 40 (step S208). Subsequently, the dealt-card display section 83 of the liquid crystal display 10 displays any one of the images inclusive of the messages “You Win”, “You Lose”, and “Draw”, during a predetermined period of time, based upon the received winner-loser information.

Next, the CPU51 receives normal-BET payout information from the main control unit 40 (step S209). Upon the receipt of the normal-BET payout information, the CPU51 stores in the RAM52 the credit data that is based upon the normal-BET payout information.

Next, the CPU51 receives normal-BET payout information, based upon the normal-BET payout information received at step S209 (step S210). In this normal-BET payout processing, in a case where a player has won, payout is performed, based upon information indicative of a credit of which amount is twice of that of the normal BET; and in a case where the result is “draw”, payout is performed, based upon information indicative of a credit of which amount is equal to that of the normal BET. In addition, in a case where the banker has won, information indicative of the fact that the amount of credit to be given is 0 is displayed.

Next, in FIG. 8B, the CPU51 judges whether or not entry of side BET has been made, while in the BET acceptance at step S202 (step S211). Specifically, the CPU51 judges whether or not a side-BET flag is set. When the CPU41 judges that entry of the side BET has not been made (step S211: NO), the routine proceeds to step S214.

On the other hand, upon judging that entry of the side BET has been made (step S211: YES), the CPU51 receives JP payout information (step S212). Specifically, the CPU51 receives JP payout information from the main control unit 40. Upon the receipt of the JP payout information, the CPU51 stores in the RAM52 the credit data that is based upon the JP payout information.

Next, the CPU51 executes JP payout processing (step S213). Specifically, the CPU51 pays out credit, based upon the JP payout information received at step S212.

Next, the CPU51 judges whether or not a side-game trigger has been established (step S214). Specifically, the CPU51 judges whether or not the side-game trigger has been established at the main control unit 40. Upon judging that no side-game trigger has been established (step S214: NO), the CPU51 terminates station processing.

On the other hand, upon judging that the side-game trigger has been established (step S214: YES), the CPU51 accepts entry of normal BET and side BET for the side game (step S215). In this manner, the player can enter the normal BET and side BET in the side game via the touch panel 11 included in the station 3.

Next, the CPU51 transmits to the main control unit 40 the BET information pertinent to BETs for the entered side game (step S216). The main control unit 40 determines cards to be dealt to the player in the side game upon the receipt of the side-game BET information (see step S117 of FIG. 11B).

Next, the CPU51 receives a sub-game card combination (step S217). Specifically, the CPU51 determines one sub-game poker combination from among the poker combinations “Royal Flush”, “Straight Flush”, “Four of a Kind”, “Full House”, “Flush”, “Straight”, “Three of a Kind”, “Two Pairs”, and “One Pair”, and then, displays a sub-game poker combination display image 70 (see FIG. 10A).

Next, the CPU51 receives from the main control unit 40 the side game dealt-card information indicative of the cards after dealt to the players in the side game (step S218). Specifically, the CPU51 receives the dealt-card information transmitted at step S118 of FIG. 11B.

Next, the CPU51 displays side-game cards (step S219). Specifically, the CPU51 displays a card image 76 indicative of the five player's cards at the dealt-card display section 83 of the liquid crystal display 10, based upon the side game dealt-card information received at step S218.

Next, the CPU51 receives the side game winner-loser information from the main control unit 40 (step S220). Next, the dealt-card display section 83 of the liquid crystal display 10 displays, for a predetermined duration, an image inclusive of any one of the messages “You Win”, “You Lose”, and “Draw”, based upon the received winner-loser information.

Next, the CPU51 receives the side-game payout information (step S221). Upon the receipt of the side-game payout information, the CPU51 stores in the RAM52 the credit data that is based upon the side-game payout information.

Next, the CPU51 executes the side-game payout processing, based upon the received side-game payout information at step S221 (step S222). In this processing operation, at step S217, payout information is received based upon information determined in any of the cases where: all of the cards displayed on the player-by-player basis include the sub-game card combination in which a payment is to be paid out, in accordance with the past game winner-loser data; a payment is paid out based upon the card combination; a payment is paid out to the player having entered a side BET; and a payment is distributed and paid out among all of the players having entered the side BET. When terminating this processing, the CPU51 terminates station processing.

Next, the game machine 1 according to a second embodiment will be described in detail with referring to the drawings. The game machine 1 according to the second embodiment that follows has an appearance and a circuit construction or the like, which are substantially similar to those according to the first embodiment of the present invention. Thus, a duplicate description of like construction is omitted here. Also, like constituent elements corresponding to those of the game machine 1 are designated by like reference numerals and are explained.

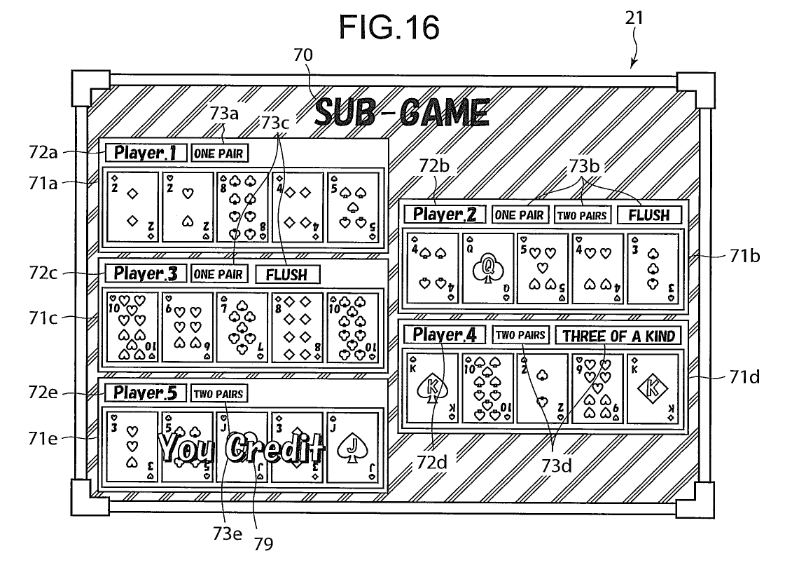

FIG. 16 is a view showing an exemplary image displayed on the front panel display in a side game according to the second embodiment. As shown in FIG. 16, when a sub game is started, the front panel display 2 displays a sub-game display image 70 indicating that the sub game has been started. Further, one or more sub-game card combination display images 73a to 73e indicating that a payment(s) is(are) paid out are displayed on the player-by-player basis from among card combinations “Royal Flush”, “Straight Flush”, “Four of a Kind”, “Full House”, “Flush”, “Straight”, “Three of a Kind”, “Two Pairs”, and “One Pair”. As card combinations in which payments are to be paid out, “One Pair” is determined for the player 1; “One Pair”, “Two Pairs”, and “Flush” for the player 2; “One Pair” and “Flush” for the player 3; “Two Pairs” and “Three of a Kind” for the player 4; and “Two Pairs” for the player 5. Further, the sub-game card combination display images 73a to 73e are displayed.

When the side-game card combination display image 70 is displayed, five cards are dealt to a plurality of players, and then, the players' cards after dealt are displayed on the front panel display 21. Here, in a case where card images 71a to 71e dealt to the players 1 to 5 are displayed, respectively, player displays 72a to 72c are displayed indicating that five players 1 to 5 are performing a sub-game, and all of the five cards after dealt on the player-by-player basis include a sub-game card combination displayed on the player-by-player basis, a payment is paid out based upon the displayed sub-game card combination. Since all of the five cards after dealt to each of the players 1 to 5 include a card combination “One Pair”, a payment is paid out to one player randomly determined from among the players 1 to 5, based upon the card combination “One Pair”. For the player for whom the payout was determined, a credit display image 79, which is inclusive of a message “You Credit”, is displayed on the card image 71.

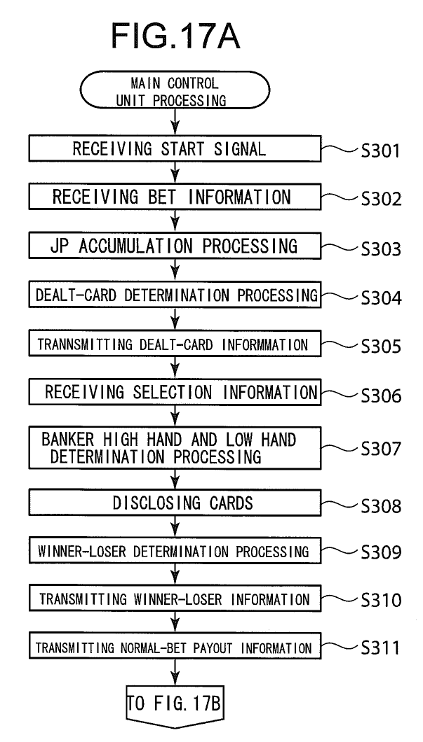

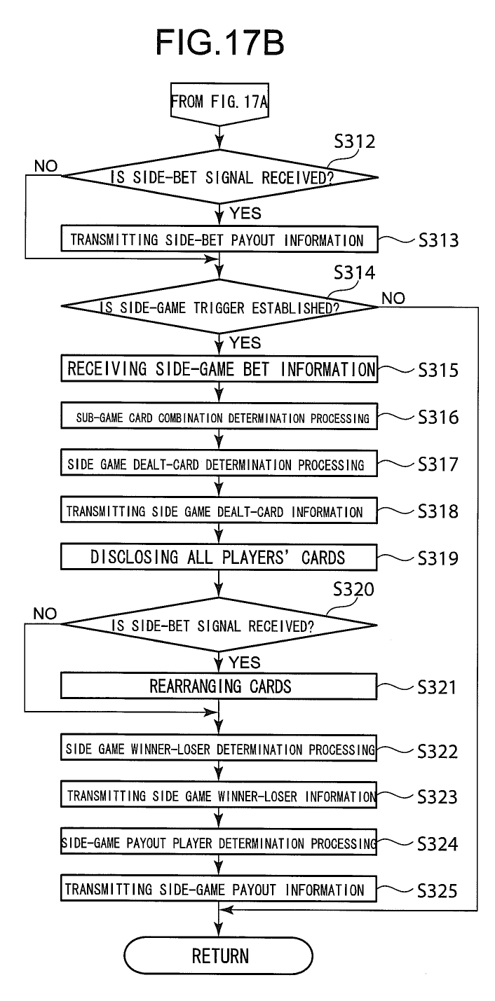

Next, the processing performed at the main control unit 40 and stations 3 will be described in detail. FIGS. 17A and 17B are flowcharts each showing main control unit processing executed at the main control unit included in the game machine according to the second embodiment. In this processing operation, at first, the CPU41 included in the main control unit 40 receives a start signal (step S301). After that, the processing operations of steps S302 to S311 are performed. These processing operations are not described here, since they are identical to those of steps S101 to S111 shown in FIG. 14A.

Next, in FIG. 17B, the CPU41 judges whether or not a side-BET signal has been received (step S312). Specifically, this CPU judges whether or not a signal indicative of the fact that a side BET is performed has been received. When the CPU judges that no side-BET signal has been received (step S312: NO), the routine proceeds to step S314.

On the other hand, when it is judged that the side-BET signal has been received (step S312: YES), the CPU41 transmits JP payout information to the stations 3 (step S313). The JP payout information is indicative of the amount of JP credit (currency value) to be paid out in response to the side BET.

Next, the CPU41 judges whether or not a side game trigger has been established (step S314). Specifically, the CPU41 executes the programs stored in the RAM42, thereby sampling random number values from among the numeric range of the predetermined random number values. Based upon the sampled random number values, this CPU judges whether or not the side game trigger has been established (step S314: NO). The CPU41 terminates main control unit processing upon executing the processing of step S314.

On the other hand, upon judging that the side game trigger has been established (step S314: YES), the CPU41 receives side-game BET information from the station 3 (refer to FIG. 2). BET information is pertinent to BETs, and includes information indicative of whether or not a normal BET and a side BET have been performed or information indicative of the amounts of the normal BET and side BET.

Next, the CPU41 executes processing of determining a card combination in a side-game (step S316). In this processing operation, the CPU41 determines one or more sub-game card combinations in which payments are to be paid out. This determination is made, according to the past game winner-loser data, from among card combinations “Royal Flush”, “Straight Flush”, “Four of a Kind”, “Full House”, “Flush”, “Straight”, “Three of a Kind”, “Two Pairs”, and “One Pair”.

Next, the CPU41 executes processing of determining side game dealt-cards (step S317). In this processing operation, from among one set of trump cards, the CPU41 determines five cards to be dealt to each of the players.

Next, the CPU41 transmits side game dealt-card information (step S318). Specifically, the CPU41 transmits the side game dealt-card information to the stations 3. The sub-game dealt-card information includes information indicative of suits (heart, clover, spade, and diamond) of cards determined to be dealt to the players. At each of the stations 3, the liquid crystal display 10 displays a card image indicative of five player's cards, based upon the received dealt-card information.

Next, the CPU41 discloses all of the players' cards (step S319). Specifically, the CPU41 controls the front panel display 21 to display the five-card image determined at step S317 in a faced up manner (see FIG. 13).

Next, the CPU41 judges whether or not a side-BET signal has been received (step S320). Specifically, the CPU41 judges whether or not a signal indicative of the fact that a side BET is performed has been received. When judging that no side-BET signal has been received (step S320: NO), the CPU41 proceeds to step S322.

On the other hand, upon judging that the side-BET signal has been received (step S320: YES), the CPU41 rearranges cards (step S321). Specifically, the CPU41 redisplays the rearranged-card image to a card image which is different from the player-selected card image.

Next, the CPU41 performs side game winner-loser determination processing (step S322). In this processing operation, the CPU41 executes processing of determining a winner or a loser, based upon the side-game cards of all of the players disclosed at step S319. Specifically, among the side-game card combinations determined at step S316, the CPU41 judges whether all of the cards displayed on the player-by-player basis include any of the determined card combinations. Then, based upon the judgment result, the CPU41 determines a winner or a loser.

Next, the CPU41 transmits side game winner-loser information (step S323). Specifically, the CPU41 transmits to the stations 3 the winner-loser information indicative of a side-game winner or loser which was determined at step S323. At each of the stations 3, upon the receipt of the winner-loser information, the liquid crystal display 10 serves to display any one of the images inclusive of the messages “You Win”, “You Lose”, and “Draw”, based upon the received winner-loser information (see FIGS. 11, 12, and 13).

Next, the CPU41 executes processing of determining a side-game payout player (step S324). Specifically, in a case where all of the cards displayed on the player-by-player basis include any of the side-game card combinations determined at step S316, from among the plurality of players, the CPU41 randomly determines a player to whom a payment corresponding to the card combination is to be paid out.

Next, the CPU41 transmits the side-game payout information to the stations 3 (step S325). The side-game payout information is indicative of the quantity of credit (currency value) to be paid out to the side game. Specifically, among the side game combinations determined at step S316, in a case where all of the cards displayed on the player-by-player basis include any of the determined card combinations, this CPU determines a payout type corresponding to the card combination (see FIG. 9), and then, transmits information indicative of the determined credit. When executing processing of step S322, the CPU41 terminates main control unit processing.

While the embodiment according to the present invention has been described, the description presents only some of the specific examples and is not intended to limit the present invention in any way and specific constructions of each means and the like can be properly changed in terms of design. Besides, the effects described in the embodiment of the present invention are only the most preferable effects generated from the present invention and the effects to be caused by the present invention is not limitative thereto.

What is claimed is:

1. A game machine, comprising:
a plurality of first display devices provided corresponding to respective ones of a plurality of players;
a second display device provided in common to the plurality of players; and
a controller for controlling the first display devices and the second display device,
the controller being programmed to:
(a) execute a basic game;
(b) display a predetermined number of players' cards on the first display devices and display a predetermined number of banker's cards on the second display, in the basic game,
(c) pay out to at least one of the players a payment determined by comparing the players' cards with the banker's cards displayed in the process (b),in the basic game;
(d) execute a side game in a case where a predetermined condition is met, in the basic game;
(e) determine, on the plural-players basis, card combination in which a payment is to be paid out, from among plural kinds of cards and then, display the determined card combination on at least one of each of the first display devices and the second display device, in the side game;
(f) display, on the first display devices, a plurality of cards dealt on the plural-players basis and display, on the second display device, a plurality of cards displayed on the first display devices and owned by the players, from among the plural kinds of cards, in the side game; and
(g) pay out a payment, based upon the combination determined in the process (e), in a case where the plurality of cards displayed on a player-by-player basis in the process (f) include the card combination determined on the plural-players basis in the process (e), in the side game.

2. The game machine according to claim 1, further comprising a memory for storing game historical data for consisting of winner-loser data of a past game accumulatively stored and table data for determining a card combination in which a payment is to be paid out, wherein:
the controller determines a plurality of card combinations in which the payments are to be paid out on the plural-players basis, with referring to the table data, according to the past winner-loser data that is based upon the game historical data stored in the memory, in the process (e).

3. The game machine according to claim 1, further comprising an input device for accepting operation from a player, wherein:
the controller is programmed to: (h) accept entry of a side BET that is different from a normal BET from the input device, and then, pay out a payment to only at least one of the players having entered the side BET in the process (g).

4. The game machine according to claim 3, wherein:
the controller distributes and pays out the payment among all of the players having entered the side BET, in the process (g).

5. The game machine according to claim 1, wherein:
the controller is programmed to: (i) execute processing of determining the player to whom a payment is to be paid out, from among the plurality of players; and
the controller pays out, in the process (g), the payment determined in the process (i).

6. A game machine, comprising:
a plurality of first display devices provided corresponding to respective ones of a plurality of players;
a second display device provided in common to the plurality of players; and
a memory for storing game historical data for consisting of winner-loser data of a past game accumulatively stored and table data for determining a card combination in which a payment is to be paid out,
a controller for controlling the first display devices, the second display device and the memory,
the controller being programmed to:
(a) execute a basic game;
(b) display a predetermined number of players' cards on the first display devices and display a predetermined number of banker's cards on the second display, in the basic game;
(c) pay out to at least one of the players a payment determined by comparing the players' cards with the banker's cards displayed in the process (b), in the basic game;
(d) execute a side game in a case where a predetermined condition is met in the basic game;
(e) determine, on the plural-players basis, a plurality of card combinations in which payments are to be paid out, from among plural kinds of cards, with referring to the table data, according to past winner-loser data that is based upon the game historical data stored in the memory in the side game, and then, display the determined card combinations on at least one of the first display devices and the second display device;
(f) display, on the first display devices, a plurality of cards dealt on the plural-players basis, and display, on the second display device, a plurality of cards displayed on the first display devices and owned by the players, from among the plural kinds of cards, in the side game; and
(g) pay out a payment, based upon the combination determined in the process (e), in a case where the plurality of cards displayed on a player-by-player basis in the process (f) include the card combination determined on the plural-players basis in the process (e), in the side game.

7. The game machine according to claim 6, further comprising an input device for accepting operation of a player, wherein:
the controller is programmed to: (h) accept entry of a side BET that is different from a normal BET from the input device, and then, pay out a payment to only at least one of the players having entered the side BET in the process (g).

8. The game machine according to claim 7, wherein:
the controller distributes and pays out the payment among all of the players having entered the side BET in the process (g).

9. The game machine according to claim 6, wherein:
the controller is programmed to: (i) execute a process of determining a player to whom a payment is to be paid out, from among the plurality of players; and
the controller pays out, in the process (g), the payment to the player determined in the process (i).

10. A game machine, comprising:
a plurality of first display devices provided corresponding to respective ones of a plurality of players;
a second display device provided in common to the plurality of players; and
a memory for storing game historical data for consisting of winner-loser data of a past game accumulatively stored and table data for determining a card combination in which a payment is to be paid out;
an input device for accepting operation from a player;
a controller for controlling the first display devices, the second display device, the memory and the input device,
the controller being programmed to:
(a) execute a basic game;
(b) display a predetermined number of players' cards on the first display devices and display a predetermined number of banker's cards on the second display in the basic game;
(c) pay out to at least one of the players a payment determined by comparing the players' cards displayed in the process (b) with the banker's cards, in the basic game;
(d) execute a side game in a case where a predetermined condition is met in the basic game;
(e) determine, on the plural-players basis, a plurality of card combinations in which payments are to be paid out, from among plural kinds of cards, with referring to the table data, according to past winner-loser data that is based upon the game historical data stored in the memory in the side game, and then, display the determined card combinations on at least one of the first display devices and the second display device;
(f) display, on the first display devices, a plurality of cards dealt on the plural-players basis and display, on the second display device, a plurality of cards displayed on the first display devices and owned by the players, from among the plural kinds of cards, in the side game;
(g) accept entry of a side BET that is different from a normal BET from the input device in the side game; and
(h) pay out a payment, based upon a card combination determined for only the player having entered the side BET in the process (g), in a case where the plurality of cards displayed on a player-by-player basis in the process (g) include the card combination determined on the plural-players basis in the process (e).

11. A method of playing card games, for performing a basic game and a side game, said method comprising the steps of:
(a) dealing to players a predetermined number of cards as players' cards and dealing to a banker a predetermined number of cards as banker's cards, in a basic game;
(b) paying out to at least one of the players a payment determined by comparing the players' cards with the banker's cards, in the basic game;
(c) determining, on a plural-players basis, a card combination in which a payment is to be paid out, from among plural kinds of cards, in a side game;
(d) dealing a plurality of cards to a plurality of players, respectively, from among plural kinds of cards, in the side game;
(e) arranging a plurality of cards owned by the plurality of players in a state in which kinds of the plurality of cards are identified to the plurality of players in the side game; and
(f) paying out a payment to a player, based upon the card combination in which a payment is to be paid out determined in the step (c), in a case where the plurality of cards arranged on the player-by-player basis in the side game include the card combinations determined on the plural-players basis in the step (c).

12. The card game playing method according to claim 11, wherein:
the step (c) comprises the step of determining a plurality of card combinations in which the payments are to be paid out on the plural-players basis, according to a past game winner/loser log.

13. The card game playing method according to claim 11, further comprising the step of (g) accepting a side BET that is different from a normal BET, wherein:
the step (f) comprises the step of paying out a payment to only at least one of the players having performed the side BET.

14. The card game playing method according to claim 13, wherein:
the step (f) comprises the step of distributing and paying out a payment among all of the players having performed the side BET, in the step (g).

15. The card game playing method according to claim 11, further comprising the step of (h) determining a player to whom a payment is to be paid out, from among the plurality of players, wherein:
the step (f) comprises the step of paying out a payment to the player determined in the step (h).

16. A card game playing method, for performing a basic game and a side game, said method comprising the steps of:
(a) dealing to players a predetermined number of cards as players' cards and dealing to a banker a predetermined number of cards as banker's cards, in a basic game;
(b) paying out to one of the players a payment determined by comparing the players' cards and the banker's cards, in the basic game;
(c) determining a plurality of card combinations in which payments are to be paid out, from among plural kinds of cards, on a plural-players basis, according to a past game winner/loser log in, a side game;
(d) dealing a plurality of cards to a plurality of players, respectively, from among plural kinds of cards, in the side game;
(e) arranging a plurality of cards owned by the plurality of players in a state in which kinds of the plurality of cards are identified to the plurality of players, in the side game; and
(f) paying out a payment to a player, based upon the card combinations in which payments are to be paid out determined in the step (c), in a case where the plurality of cards arranged on the player-by-player basis in the step (c) include the card combinations determined on the plural-players basis in the step (c).

17. The card game playing method according to claim 16, further comprising the step of (g) accepting a side BET that is different from a normal BET, wherein:
the step (f) comprises the step of paying out a payment to only at least one of the players having performed the side BET.

18. The card game playing method according to claim 17, wherein:
the step (f) comprises the step of distributing and paying out a payment among all of the players having performed the side BET, in the step (g).

19. The card game playing method according to claim 17, further comprising the step of (h) determining a player to whom a payment is to be paid out, from among the plurality of players, wherein:
the step (f) comprises the step of paying out a payment to the player determined in the step (h).
